(19) United States
(12) Patent Application Publication
(10) Pub. No.: US 2026/0038108 A1
(43) Pub. Date: Feb. 5, 2026

(54) SYMMETRIC CYCLEGAN FOR SEM-TO-DESIGN IMAGE REGISTRATION

(71) Applicant: KLA Corporation, Milpitas, CA (US)

(72) Inventors: Rahul RAJENDRAN, Belleville, MI (US); Vijai THOTTATHIL JAYADEVAN, Canton, MI (US); Mohammadreza RAVANFAR, San Jose, CA (US); Hawren FANG, San Jose, CA (US); Huan JIN, Dublin, CA (US)

(21) Appl. No.: 19/285,837

(22) Filed: Jul. 30, 2025

Related U.S. Application Data
(60) Provisional application No. 63/679,174, filed on Aug. 5, 2024.

(51) Int. Cl. G06T 7/00; G06T 7/32

(52) U.S. Cl. CPC G06T 7/0006; G06T 7/001; G06T 7/32; G06T 2207/10061; G06T 2207/20081; G06T 2207/20084; G06T 2207/30148

(57) ABSTRACT

A synthetic image of a semiconductor device structure is generated from a design image using a symmetric CycleGAN. The symmetric CycleGAN includes a neural network architecture that learns bidirectional mappings between a design image domain and a workpiece image domain. The synthetic image is aligned to a workpiece image (e.g., a SEM image) of the device structure on the workpiece corresponding to the synthetic image thereby generating an aligned image. The aligning is provided by domain translation performed by the symmetric CycleGAN.

### CROSS-REFERENCE TO RELATED APPLICATIONS

This application claims priority to the provisional patent application filed Aug. 5, 2024 and assigned U.S. App. No. 63/679,174, the disclosure of which is hereby incorporated by reference.

### FIELD OF THE DISCLOSURE

This disclosure relates to image alignment for semiconductor inspection.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. As design rules shrink, the population of potentially yield-relevant defects detected by inspection grows dramatically, and the population of nuisance defects detected by inspection also increases dramatically. Therefore, more defects may be detected on the wafers, and correcting the processes to eliminate all of the defects may be difficult and expensive. Determining which of the defects actually have an effect on the electrical parameters of the devices and the yield may allow process control methods to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

Image alignment can be performed during inspection. Previously, linear filters or pattern-to-design alignment (PDA) were used to align an SEM image to the corresponding design image. A PDA model can include a physics-based component, referred to as the partially coherent model (PCM). PDA aligns optical images to the design and, thus, enables accurate placement of care areas. Image registration errors up to approximately four to five pixels have been observed using PDA. PDA models also tend to need high alignment accuracy.

In the context of die-to-database (D2DB) inspection or review in semiconductor manufacturing, scanning electron microscope (SEM) images can be aligned with design images. This alignment is used to detect defects, analyze yield issues, and develop early-stage inspection algorithms. However, direct registration between SEM and design images is hindered by their differing modalities and substantial SEM specific noise introduced by process variation, shot noise, and charging effects. As a result, traditional alignment techniques fail to produce robust results.

One potential strategy to mitigate the modality gap is to translate design images into synthetic SEM images and perform alignment in this more compatible space. This, however, introduces a new challenge. Training a design-to-SEM translator typically requires paired and aligned samples of design and SEM images, which are not readily available due to the difficulty of obtaining precise correspondences.

Therefore, improved systems and techniques are needed.

### BRIEF SUMMARY OF THE DISCLOSURE

A method is provided in a first embodiment. The method includes receiving a design image of a semiconductor device structure on part of a surface of a workpiece. A synthetic image of the semiconductor device structure is generated from the design image using a symmetric CycleGAN. The symmetric CycleGAN comprises a neural network architecture configured to learn bidirectional mappings between a design image domain and a workpiece image domain. The synthetic image is aligned to a workpiece image of the device structure on the workpiece corresponding to the synthetic image thereby generating an aligned image. The aligning is provided by domain translation performed by the symmetric CycleGAN.

The method may include imaging the device structure on the workpiece corresponding to the synthetic image using an electron beam inspection system thereby generating the workpiece image.

The method may include performing defect detection using the aligned image.

The symmetric CycleGAN may be configured to achieve symmetry using symmetric kernels in convolutional layers of a neural network of the symmetric CycleGAN.

The method may include performing a regularization. The regularization includes a dynamic weighting mechanism applied to normalized cross-correlation (NCC) loss. The weighting mechanism can be configured to emphasize regions of low similarity or high uncertainty between fixed and moving images.

An inspection system is provided in a second embodiment. The inspection system includes a stage configured to hold a workpiece; an electron beam source configured to direct an electron beam at the workpiece on the stage; a detector configured to collect secondary electrons and/or back scattered electrons from the workpiece; and a processor in electronic communication with the detector. The processor is configured to receive a design image of a semiconductor device structure on part of a surface of the workpiece; generate a synthetic image of the semiconductor device structure from the design image using a symmetric CycleGAN; and align the synthetic image to a workpiece image of the device structure on the workpiece corresponding to the synthetic image thereby generating an aligned image. The symmetric CycleGAN comprises a neural network architecture configured to learn bidirectional mappings between a design image domain and a workpiece image domain. The aligning is provided by domain translation performed by the symmetric CycleGAN.

The inspection system may be configured to send instructions to image the device structure on the workpiece corresponding to the synthetic image using the electron beam thereby generating the workpiece image.

The processor may be configured to perform defect detection using the aligned image.

The symmetric CycleGAN may be configured to achieve symmetry using symmetric kernels in convolutional layers of a neural network of the symmetric CycleGAN.

The processor may be further configured to perform a regularization. The regularization can include a dynamic weighting mechanism applied to NCC loss. The weighting mechanism may be configured to emphasize regions of low similarity or high uncertainty between fixed and moving images.

A non-transitory computer-readable storage medium that includes one or more programs for executing the following steps on one or more computing devices is provided in a third embodiment. The steps include receiving a design image of a semiconductor device structure on part of a surface of a workpiece; generating a synthetic image of the semiconductor device structure from the design image using a symmetric CycleGAN; and aligning the synthetic image to a workpiece image of the device structure on the workpiece corresponding to the synthetic image thereby generating an aligned image. The symmetric CycleGAN comprises a neural network architecture configured to learn bidirectional mappings between a design image domain and a workpiece image domain. The aligning is provided by domain translation performed by the symmetric CycleGAN.

The steps may include sending instructions to image the device structure on the workpiece corresponding to the synthetic image using a scanning electron microscope thereby generating the workpiece image.

The steps may include performing defect detection using the aligned image.

The symmetric CycleGAN may be configured to achieve symmetry using symmetric kernels in convolutional layers of a neural network of the symmetric CycleGAN.

The steps may include performing a regularization. The regularization may include a dynamic weighting mechanism applied to NCC loss. The weighting mechanism may be configured to emphasize regions of low similarity or high uncertainty between fixed and moving images.

### DESCRIPTION OF THE DRAWINGS

For a fuller understanding of the nature and objects of the disclosure, reference should be made to the following detailed description taken in conjunction with the accompanying drawings, in which:

FIG. 1 is a block diagram of a CycleGAN;

FIG. 2 illustrates cycle-consistency loss;

FIG. 3 illustrates an embodiment that makes a convolutional neural network symmetric in accordance with the present disclosure;

FIG. 4 is an exemplary design image;

FIG. 5 is an exemplary SEM image;

FIG. 6 is an exemplary synthetic image using an embodiment in accordance with the present disclosure;

FIG. 7 is a flowchart of an embodiment of a method in accordance with the present disclosure; and

FIG. 8 is a diagram of an inspection system in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

In D2DB inspection or review, the algorithm aligns a test image of a workpiece (e.g., a semiconductor wafer) to the design (database) image. When the test images are scanning electron microscope (SEM) images, strong workpiece noise caused by process variation and tool noise (e.g., shot noise, charging effect, etc.) can affect the test image.

Aligning a test SEM image directly to the design image based on normalized cross correlation (NCC) may not be reliable because SEM images and design images are of two different modalities. Design images are a type of synthetic image based on the design of a workpiece. A design-to-SEM image translator can translate a design image or design file to a synthetic image, which can then be aligned to the SEM image. If pairs of design and SEM images are well-aligned to each other, then a design-to-SEM translator can be trained as a neural network to approximate the mapping from the design image or design file to SEM image. A symmetric CycleGAN is disclosed herein, which does not require paired design and SEM images to train. The symmetric CycleGAN can provide a neural network for design-to-SEM translation for SEM-to-design image registration. In the embodiment disclosed herein, the symmetric CycleGAN, as a deep learning method, is more suitable than the conventional algorithm based on linear filters.

Symmetric CycleGAN embodiments disclosed herein use symmetric kernels in convolutional layers of a convolutional neural network (CNN) to prevent geometric offset in design-to-SEM image translation. The network architecture of the generators in the symmetric CycleGAN can be lighter than previous open-source implementation, to address the arbitrary mapping issue. Embodiments of the symmetric CycleGAN may use focal normalized cross correlation (Focal NCC) regularization that improves the fidelity of the generated synthetic SEM images, which can enable increased accuracy of SEM-to-design image registration. Symmetric CycleGAN is a model that translates design images to SEM-like images, which is used to align the real SEM images. The design and real SEM images need to be aligned. Using traditional algorithms to align the design to the workpiece SEM image typically will not work because these are images from two different image domains. The embodiments disclosed herein first translate the image from the design domain to the workpiece image domain (e.g., a SEM image), and use this image to align the workpiece image.

CycleGAN is a type of deep learning model used for unpaired image-to-image translation. It is employed to translate design images into SEM images. Unlike traditional methods that require paired examples (one-to-one correspondence), CycleGAN can learn mappings between different modalities without explicit alignment. The model learns to map design to SEM representations and vice versa, even though there is no direct correspondence.

The network architecture of the generators in the symmetric CycleGAN can be made lighter than open-source implementation because a conventional CycleGAN model had more feature extraction layers. In an example of a previous architecture, there are five layers (levels) that go down and five layer (levels) that come up. This defines the depth of the model. This was reduced to two layers that go up and down in the embodiments disclosed herein. The number of filters used at each level also were reduced in the embodiments disclosed herein. Whereas the previous model had over fifteen million parameters, the disclosed symmetric CycleGAN has only approximately sixteen thousand parameters. This demonstrates the reduction in size.

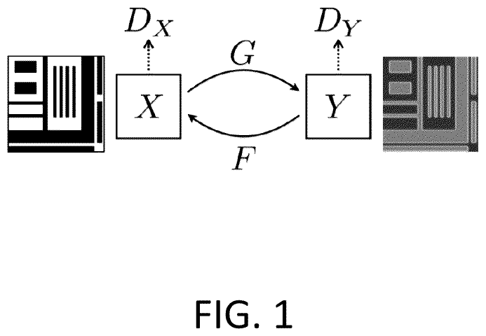

FIG. 1 is a block diagram of a CycleGAN. Two generators G:X→Y and F:Y→X are used for spaces of two modalities X,Y. X, Y are spaces of design and SEM images, respectively. There are two discriminators D_{X}(x) and D_{Y}(y). In an instance, two GANs involving two generators G:X→Y, F:Y→X and two discriminators are trained concurrently. One generator learns to translate images from domain X to domain Y and the other does the reverse, as shown in FIG. 1. Cycle consistency loss can ensure that if an image is translated from domain X to domain Y and back again, the result should closely resemble the original image. This encourages structural fidelity and prevents the network from learning arbitrary mappings that ignore the input's semantic content.

To provide SEM-to-design image alignment, the generator G is made symmetric by using symmetric convolution filters in the network, for translating a given SEM image x to a SEM-like model image y without introducing geometric offset. Cycle consistency loss can result in the two learned mappings (from domain X to Y and vice versa) being inverse functions of each other. This implicitly encourages a one-to-one correspondence at the sample level for unpaired image translation.

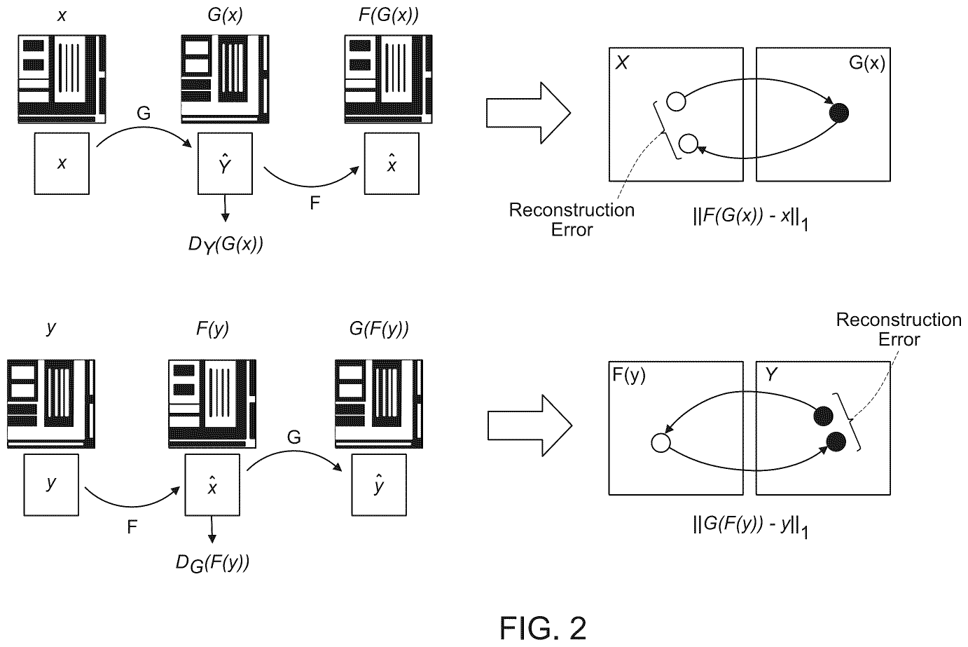

FIG. 2 illustrates cycle-consistency loss. The cycle consistency loss measures how different the original design image is from the one obtained after the double translation. This difference may be minimized. Mathematically, it can be expressed like in the following equation.

$${ℒ}_{cyc} ( G , F ) = {𝔼}_{x ∼ {p}_{data} ( x )} [ {‖ F ( G ( x ) ) - x ‖}_{1} ] + {𝔼}_{y ∼ {p}_{data} ( y )} [ {‖ G ( F ( y ) ) - y ‖}_{1} ]$$

G:X→Y is a generator that maps images from domain X to domain Y. F:Y→X is a generator that maps images from domain Y to domain X. x˜pdata(x) is a sample image from domain X. y˜pdata(y) is a sample image from domain Y. ∥·∥1 is the L1 norm (sum of absolute differences) used to measure reconstruction error. The first term Ex˜pdata(x)[∥F(G(x))−x∥1] ensures that translating an image x to domain Y and back to domain X reconstructs the original image. The second term Ey˜pdata(y)[∥G(F(y))−y∥1] ensures the same for images from domain Y.

To deal with issues like offset shift, noise, arbitrary mapping and incorrect line segment length, following solutions may be used. Symmetric kernels can be applied to handle any shift issues. A smaller network can be used with the reduced receptive field size for the generators. A de-noising algorithm can be used to remove the noise from the training SEM images during training. Focal NCC may be introduced against the issue of incorrect line segment length. Focal NCC introduces dynamic weighting to emphasize regions of the image where alignment is more difficult or uncertain like focal loss in classification, which down-weights easy examples and focuses on hard ones. Focal NCC can include a dynamic weighting mechanism applied to NCC loss. The dynamic weighting mechanism may be configured to emphasize regions of low similarity or high uncertainty between fixed and moving images.

A learnt filter may introduce geometric shift/offset. A pair of I_{design} and I_{SEM} may not be well aligned to each other, as shown in the following matrices.

$${I}_{design} = [ \begin{matrix}0 & 255 & 0 \\ 0 & 255 & 0 \\ 0 & 255 & 0\end{matrix} ] , {I}_{SEM} = [ \begin{matrix}150 & 0 & 0 \\ 150 & 0 & 0 \\ 150 & 0 & 0\end{matrix} ]$$

A model may be realized by a single filter F as: I_{Model}=I_{design}⊗C. If I_{SEM} is fit by I_{Model}, the learnt convolutional filter is as follows.

$$C = [ \begin{matrix}0 & 0 & 0 \\ 0.59 & 0 & 0 \\ 0 & 0 & 0\end{matrix} ]$$

This example explains that if the image-to-image translation model is not constrained to be symmetric, then the model may learn asymmetric transformations that introduce undesirable shifts. The offset may hurt image alignment. Consider a model ƒ_{θ} for image-to-image translation that performs image-to-image translation from I_{design} to a synthetic SEM image, where θ denotes model parameters (trainable variables). Design image I_{design} can be translated to synthetic SEM image. Therefore, ƒ_{θ} is symmetric if it satisfies the following equation for any given I_{design} and all three types of flip functions (i.e., horizontal flip, vertical flip, or both). This condition ensures that the model's output remains consistent under geometric transformations, thereby preventing the introduction of directional biases or offsets.

$${f}_{θ} ( {I}_{design} ) = flip ( {f}_{θ} ( flip ( {I}_{design} ) ) )$$

In the above example, the model is ƒ_{C}(I_{design})=I_{design}⊗C. A learnt filter can introduce a geometric shift or offset. Consider two images: a design image I_{design} and a corresponding SEM image I_{SEM}, which may not be perfectly aligned. This model is represented by a single convolutional filter C. Here, ⊗ denotes the convolution operation. If this model is trained to approximate I_{SEM}, the learned filter C may inherently include an offset to compensate for the misalignment between I_{design} and I_{SEM}. This offset becomes embedded in the model, potentially leading to systematic geometric distortions in the output.

If the convolutional filter C is constrained to be symmetric, then the model ƒ_{C} is also symmetric. This provides a technique to make a CNN symmetric. If all

$${w}_{p , q}^{( n )}$$

(which represents the weight of the kernel) are symmetric, then

$${\sum }_{q = 1}^{{N}_{ch}^{( n - 1 )}} {u}_{q}^{( n - 1 )} ⊗ {w}_{p , q}^{( n )}$$

is a sum of symmetric functions with respect to

$${u}_{q}^{( n - 1 )}$$

(which represents the image or the feature map) and therefore remains symmetric. The bias

$${b}_{p}^{( n )}$$

and the activation function a do not negatively affect the symmetry. As a result, a convolution layer is symmetric if all filters

$${w}_{p , q}^{( n )}$$

are symmetric. Thus, a convolutional neural network is symmetric if all filters are symmetric.

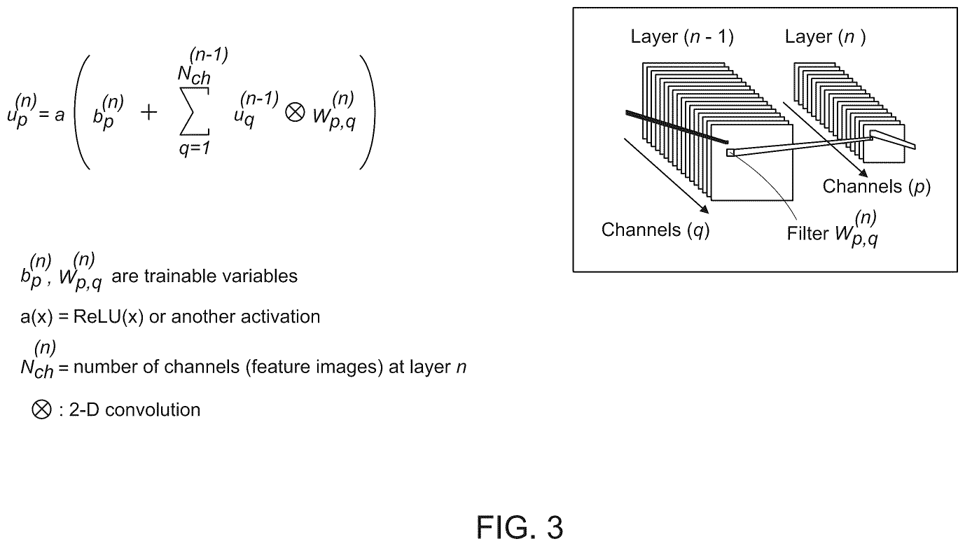

FIG. 3 illustrates an embodiment that makes a convolutional neural network symmetric.

$${b}_{p}^{( n )}$$

is a bias parameter.

$${w}_{p , q}^{( n )}$$

is a conventional layout, which can be the weights of the kernel. If the layer in FIG. 3 is made symmetric, then the model will be symmetric. Consider a single layer defined as follows.

$${u}_{p}^{( n )} = a ( {b}_{p}^{( n )} + {\sum }_{q = 1}^{{N}_{c h}^{( n - 1 )}} {u}_{q}^{( n - 1 )} ⊗ {w}_{p , q}^{( n )} )$$

$${b}_{p}^{( n )} , {w}_{p , q}^{( n )}$$

are trainable variables, a is the activation function,

$${N}_{c h}^{( n )}$$

is the number of channels at layer n, and ⊗ is a 2D convolution operator. If

$${w}_{p , q}^{( n )}$$

are symmetric, then

$${Σ}_{q = 1}^{{N}_{c h}^{( n - 1 )}} {u}_{q}^{( n - 1 )} ⊗ {w}_{p , q}^{( n )}$$

is a sum of symmetric functions with respect to

$${u}_{p}^{( n - 1 )}$$

and, therefore, remains symmetric. The bias

$${b}_{p}^{( n )}$$

and activation function a do not hurt the symmetry. As a result, a convolution layer is symmetric if all filters

$${w}_{p , q}^{( n )}$$

are symmetric. Thus, a CNN like the symmetric CycleGAN is symmetric if all filters are symmetric.

The kernel (as a normal convolutional kernel) for i^{th} in channel and j^{th} out channel can be denoted by the following.

$${W}_{i , j} = [ \begin{matrix}{a}_{11} & ⋯ & {a}_{1 N} \\ ⋮ & ⋱ & ⋮ \\ {a}_{N 1} & ⋯ & {a}_{NN}\end{matrix} ]$$

A symmetric kernel (subject to division by a constant scalar, such as two) can be formed as follows.

$${\tilde{W}}_{i , j} = [ \begin{matrix}{a}_{11} & ⋯ & {a}_{1 N} \\ ⋮ & ⋱ & ⋮ \\ {a}_{N 1} & ⋯ & {a}_{NN}\end{matrix} ] + [ \begin{matrix}{a}_{N 1} & ⋯ & {a}_{NN} \\ ⋮ & ⋱ & ⋮ \\ {a}_{11} & ⋯ & {a}_{1 N}\end{matrix} ] + [ \begin{matrix}{a}_{1 N} & ⋯ & {a}_{11} \\ ⋮ & ⋱ & ⋮ \\ {a}_{N N} & ⋯ & {a}_{N 1}\end{matrix} ] + [ \begin{matrix}{a}_{NN} & ⋯ & {a}_{N 1} \\ ⋮ & ⋱ & ⋮ \\ {a}_{1 N} & ⋯ & {a}_{11}\end{matrix} ]$$

\tilde{W}ᵢⱼ is the symmetric convolutional filter of i^{th} in channel and j^{th} out channel.

Symmetric CycleGAN successfully addresses the shift issue and the arbitrary mapping problem. The generated features closely resemble those found in the real SEM images. The noise information observed in real SEM images is not present in the generated SEM images.

Upon generating the synthetic images, the alignment process was performed using NCC between the SEM image and the synthetic image in an example. A minor offset in the alignment results was noticed when alignment process was performed using NCC. The offset resulted from the height and width of the line patterns in the synthetic images not matching that of the SEM images. To overcome this issue in the mismatch of the line width and height, focal NCC regularization was implemented.

Consider the cross-correlation regularization loss added to the training loss of the trained network as follows.

$$- μ \cdot max ( g ( {I}_{SEM} ) * g ( {I}_{model} ) )$$

In this equation, μ>0 is the hyperparameter that controls the influence of cross-correlation regularization on the training process. g(I) is the function that preprocesses the input image/using zero-mean normalization without changing the image size. “★” denotes cross correlation operation considering only the “valid” region, which ensures that the output is not padded and only includes regions where the two inputs fully overlap. Lines in the synthetic image may better match the design with wider, thicker lines. Note that I_{model} and I_{SEM} have different sizes. If the search range is k=6 pixels in both x-direction and y-direction, then I_{model} should be smaller (or larger) than I_{SEM} by 12 pixels in both x-direction and y-direction. The result ƒ(I_{SEM})★ƒ(I_{model}) is of size (2k+1)×(2k+1) and max(ƒ(I_{SEM})★ƒ(I_{model})) takes the peak value. The focal NCC regularization model provides a better pattern generation and solves this problem. A synthetic image may match the actual image more than the design and a more uniform image can be provided.

When performing convolution or correlation between an input (e.g., an image or signal) and a kernel (e.g., a filter), the valid region is the set of positions where the kernel can be applied without going outside the boundaries of the input. No padding may be used. The kernel is entirely within the input at each position. The output is smaller than the input. For example, with an input of size 5×5 and a kernel of size 3×3, in a valid convolution the kernel can only slide over positions where it fully fits inside the input. The output size will be (5−3+1)×(5−3+1)=3×3.

For focal NCC regularization, g(I_{SEM})★g(I_{model}) has values approximately bounded in [−1,1]. To enforce values bounded in [−1,1], let [symbol] =min{1, max{−1, g(I_{SEM})★g(I_{model})}}, with min and max applied element-wise. Here, [symbol] is of size (2k+1)×(2k+1), with k the (assumed) maximum offset between I_{SEM} and I_{model}. Let NCC*=max( [symbol] ), then NCC∈[−1,1]. Consider

$$\frac{1}{2} ( 1 - N C {C}^{*} ) ∈ [ 0 , 1 ]$$

for weighting. The closer NCC* to 1, the less weight is used. The focal NCC regularization term is as follows.

$$- μ \cdot {( \frac{1}{2} ( 1 - N C {C}^{*} ) )}^{γ} \cdot N C {C}^{*}$$

γ≥0 controls the intensity of the weight such that γ=0 means no weighting. Thus, dynamic weighting is applied to NCC regularization in focal NCC regularization. This regularization encourages the network to produce feature representations from the model that are maximally aligned with those from the SEM images, thereby promoting consistency and improving generalization. Generated SEM images exhibit improved quality, particularly around the borders, where artifacts or distortions are often more pronounced. Additionally, the structural features such as line width and length are more accurately preserved and closely resemble those found in real SEM images. Artifacts and distortion are less likely to cause an alignment algorithm to align to a random feature. Alignment can be performed using NCC, which can overcome mismatch of the line width and height.

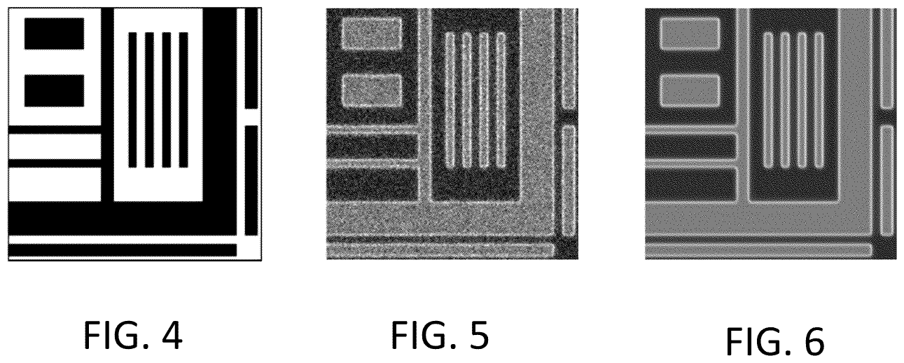

FIGS. 4-6 demonstrate the effects. FIG. 4 is an exemplary design image. FIG. 5 is a SEM image that corresponds to the design image. FIG. 6 is a synthetic image generated using the embodiments disclosed herein.

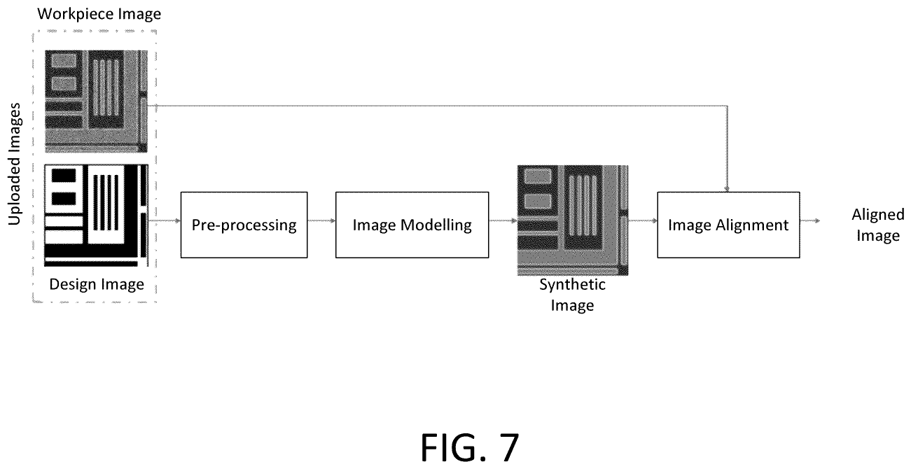

FIG. 7 is a flowchart of an embodiment of a method. A design image of a semiconductor device structure on part of a surface of a workpiece (e.g., semiconductor wafer) can be received. The design image can be generated from a design file of the workpiece. A workpiece image, which can be generated by a SEM also can be received. The workpiece image and the design image are unpaired. The device structure on the workpiece corresponding to the synthetic image can be imaged using the SEM or another electron beam inspection system to generate the workpiece image.

Features printed on the wafer come from the design file. The feature in the SEM image should match the design. Otherwise, there is a defect. In terms of CycleGAN using unpaired images, which means the design and SEM do not need to have the same structural features during training, the model focuses on keeping the structure of the design file but adds the style from the SEM image.

The design image can optionally be pre-processed. Pre-processing can include smoothing the image or augmenting the image (e.g., flipping or rotating the image). Then image modelling can be performed using a symmetric CycleGAN. The symmetric CycleGAN can generate a synthetic image of the semiconductor device structure from the design image. The synthetic image can be aligned to a workpiece image of the device structure on the workpiece corresponding to the synthetic image thereby generating an aligned image. An alignment algorithm using NCC can be used to align the synthetic image to the workpiece image.

Defect detection or workpiece inspection can be performed using the aligned image. Various defect detection algorithms may be used. After the images are aligned using symmetric CycleGAN, a reference image can be generated. This reference image may be like a golden image or ground truth image that can be used to compare to the workpiece image. This reference image can be created if the workpiece is aligned to the design (as provided by symmetric CycleGAN). Differences between the golden image and the workpiece image are then categorized as defective or normal.

The symmetric CycleGAN can be configured to achieve symmetry using symmetric kernels in convolutional layers of a neural network of the symmetric CycleGAN. Regularization can be performed to apply dynamic weighting to cross-entropy loss, such as using focal NCC.

The symmetric version of CycleGAN can address the issue of geometric offset in design-to-SEM image translation. An image-to-image translation model ƒ_{θ} is called symmetric if it is flip-invariant. The flip operator can be flip upside-down or left-to-right. The symmetry is achieved by using symmetric kernels in the convolutional layers of the neural network. Focal NCC regularization can enhance the quality of the synthetic SEM images generated by the symmetric CycleGAN. This improvement in image fidelity can lead to increased accuracy when registering or aligning SEM images back to their corresponding design images. This can enable small defect detection in semiconductor manufacturing, where precise alignment between design and SEM images may be needed.

In an example, an embodiment of a conventional CycleGAN model was trained using a dataset consisting of 1,000 images from design and SEM, each having a size of 288×288 pixels. The training was conducted on a system equipped with four NVIDIA A10 GPUs. The model was trained for 200 epochs, with an initial learning rate of 0.0008, with an exponential decay rate=0.96. The AdamW optimizer was employed with β₁=0.5 and β₂=0.9. A global batch size of 128 was used and data augmentation techniques such as vertical flipping and normalization were applied to improve generalization.

During testing, 100 unseen images from each domain were used to evaluate the model's performance. The generator trained to map from design to SEM was used to translate design images, and the quality of the output was assessed. One of the noticeable issues was a spatial misalignment between the input design images and the generated synthetic SEM images. This offset, often visible in specific regions, indicates that the model introduces unintended geometric shifts during translation, compromising the alignment results. In networks like CycleGAN, convolutional filters are learned to transform images from one domain to another. These filters operate over local regions of the image and can inadvertently introduce spatial transformations, such as shifts or distortions, even though the model is not explicitly trained to perform geometric changes. To illustrate this, consider a simple 5×5 matrix representing an image with a single bright pixel at the center. When a convolutional filter is applied and designed to emphasize or shift certain pixel positions, it can move the bright pixel to a different location, such as one position to the right. This simulates a geometric shift introduced by the learned filter. In the context of CycleGAN, the model then applies a second transformation (another learned filter) to map the image back to its original domain. This second filter can shift the pixel back to its original position, effectively reconstructing the original image. Despite the intermediate image having a spatial offset, the cycle consistency loss remains low because the final reconstruction closely matches the original input. This demonstrates how CycleGAN can learn transformations that include geometric shifts if the overall cycle is preserved.

The magnitude of the geometric shift was inversely related to the density of patterns in the input design. Specifically, when the design image contained fewer features or patterns, the resulting shift in the synthetic SEM image was more pronounced. This suggests that CycleGAN relies heavily on contextual information to anchor spatial relationships.

The original CycleGAN architecture employs convolutional layers with large receptive fields, which can lead to arbitrary and non-local mappings between features in the design and SEM domains. This means a feature in the design image might be turned into something unrelated or far away in the SEM image, making the result less accurate and harder to understand. The model had a tendency to learn and replicate shot noise present in the training SEM images. While this may enhance the visual realism of the generated outputs, it introduces artifacts that can negatively impact downstream tasks such as image registration, segmentation, or quantitative analysis.

CycleGAN relies on adversarial training, where the discriminator evaluates the realism of generated images. However, the discriminator may focus primarily on texture and global appearance, rather than precise geometric properties. As a result, the generator can produce line segments with incorrect lengths or proportions, which the discriminator fails to penalize.

To address the issue of geometric shifts and directional bias, symmetric CycleGAN embodiments disclosed herein apply symmetric convolutional kernels in the generator architecture. These kernels help maintain spatial alignment by ensuring that the learned filters do not favor any particular direction, thereby reducing unintended offsets in the output. The generator network size also is reduced in embodiments disclosed herein, which effectively decreases the receptive field. A smaller receptive field limits the model's ability to connect distant parts of the image, which helps it focus on local details and produce more accurate and consistent translations between design and SEM images. To prevent the model from learning and reproducing shot noise, a de-noising algorithm can be applied to the SEM images in the training set of the embodiments disclosed herein. This step is performed only during training, allowing the model to focus on learning meaningful structural features while preserving the realism of inference time outputs. Focal NCC can address inaccuracies in line segment lengths. This technique emphasizes local structural alignment by penalizing geometric discrepancies in critical regions, guiding the generator to produce outputs with more accurate and consistent dimensions.

The amount of training for a symmetric CycleGAN algorithm may depend on the workpiece. If the design images are diverse, then training may take longer. Thus, the training time can depend on image resolution, batch size, dataset size, hardware, or other issues.

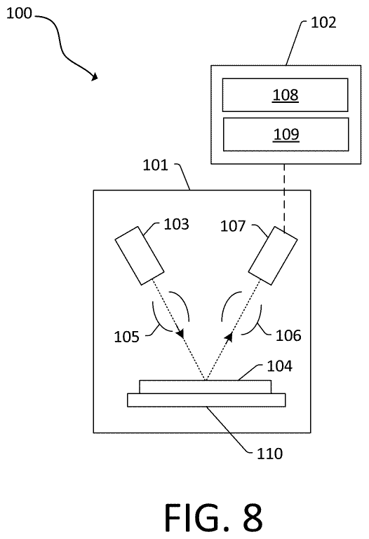

FIG. 8 is a block diagram of an embodiment of a system 100. The system 100 includes a workpiece inspection system (which includes the electron column 101) configured to generate images of a workpiece 104 (e.g., a semiconductor wafer).

The system 100 includes an output acquisition subsystem that includes at least an energy source and a detector. The output acquisition subsystem may be an electron beam-based output acquisition subsystem. For example, in one embodiment, the energy directed to the workpiece 104 includes electrons, and the energy detected from the workpiece 104 includes electrons. In this manner, the energy source may be an electron beam source. In one such embodiment shown in FIG. 8, the output acquisition subsystem includes electron column 101, which is coupled to computer subsystem 102. A stage 110 may hold the workpiece 104.

As also shown in FIG. 8, the electron column 101 includes an electron beam source 103 configured to generate electrons that are focused to workpiece 104 by one or more elements 105. The electron beam source 103 may include, for example, a cathode source or emitter tip. The one or more elements 105 may include, for example, a gun lens, an anode, a beam limiting aperture, a gate valve, a beam current selection aperture, an objective lens, and a scanning subsystem, all of which may include any such suitable elements known in the art.

Electrons returned from the workpiece 104 (e.g., secondary electrons) may be focused by one or more elements 106 to detector 107. One or more elements 106 may include, for example, a scanning subsystem, which may be the same scanning subsystem included in element(s) 105. The detector 107 may collect secondary electrons and/or back scattered electrons from the workpiece 104 to generate an image of the workpiece 104.

The electron column 101 also may include any other suitable elements known in the art.

Although the electron column 101 is shown in FIG. 8 as being configured such that the electrons are directed to the workpiece 104 at an oblique angle of incidence and are scattered from the workpiece 104 at another oblique angle, the electron beam may be directed to and scattered from the workpiece 104 at any suitable angles. In addition, the electron beam-based output acquisition subsystem may be configured to use multiple modes to generate images of the workpiece 104 (e.g., with different illumination angles, collection angles, etc.). The multiple modes of the electron beam-based output acquisition subsystem may be different in any image generation parameters of the output acquisition subsystem.

Computer subsystem 102 may be coupled to detector 107 as described above. The detector 107 may detect electrons returned from the surface of the workpiece 104 thereby forming electron beam images of the workpiece 104, such as the SEM images described herein. The electron beam images may include any suitable electron beam images. Computer subsystem 102 may be configured to perform any of the functions described herein using the output of the detector 107 and/or the electron beam images. Computer subsystem 102 may be configured to perform any additional step(s) described herein. A system 100 that includes the output acquisition subsystem shown in FIG. 8 may be further configured as described herein.

It is noted that FIG. 8 is provided herein to generally illustrate a configuration of an electron beam-based output acquisition subsystem that may be used in the embodiments described herein. The electron beam-based output acquisition subsystem configuration described herein may be altered to optimize the performance of the output acquisition subsystem as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

Although the output acquisition subsystem is described above as being an electron beam-based output acquisition subsystem, the output acquisition subsystem may be an ion beam-based output acquisition subsystem. Such an output acquisition subsystem may be configured as shown in FIG. 8 except that the electron beam source may be replaced with any suitable ion beam source known in the art. In addition, the output acquisition subsystem may be any other suitable ion beam-based output acquisition subsystem such as those included in commercially available focused ion beam (FIB) systems, helium ion microscopy (HIM) systems, and secondary ion mass spectroscopy (SIMS) systems.

The computer subsystem 102 includes a processor 108 and an electronic data storage unit 109. The processor 108 may include a microprocessor, a microcontroller, or other devices. The processor 108 may be a CPU or GPU. While one processor 108 is illustrated, more than one processor 108 may be used.

The computer subsystem 102 may be coupled to the components of the system 100 in any suitable manner (e.g., via one or more transmission media, which may include wired and/or wireless transmission media) such that the processor 108 can receive output. The processor 108 may be configured to perform a number of functions using the output. The workpiece inspection system can receive instructions or other information from the processor 108. The processor 108 and/or the electronic data storage unit 109 optionally may be in electronic communication with another workpiece inspection system, a workpiece metrology system, or a workpiece review system (not illustrated) to receive additional information or send instructions.

The processor 108 is in electronic communication with the wafer inspection system, such as the detector 107. The processor 108 may be configured to process images generated using measurements from the detector 107. For example, the processor may perform embodiments of the methods described herein.

The computer subsystem 102, other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 108 and electronic data storage unit 109 may be disposed in or otherwise part of the system 100 or another device. In an example, the processor 108 and electronic data storage unit 109 may be part of a standalone control unit or in a centralized quality control unit. Multiple processors 108 or electronic data storage units 109 may be used.

The processor 108 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 108 to implement various methods and functions may be stored in readable storage media, such as a memory in the electronic data storage unit 109 or other memory.

If the system 100 includes more than one computer subsystem 102, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 108 may be configured to perform a number of functions using the output of the system 100 or other output. For instance, the processor 108 may be configured to send the output to an electronic data storage unit 109 or another storage medium. The processor 108 may be further configured as described herein.

The processor 108 or computer subsystem 102 may be part of a defect review system, an inspection system, a metrology system, or some other type of system. Thus, the embodiments disclosed herein describe some configurations that can be tailored in a number of manners for systems having different capabilities that are more or less suitable for different applications.

The processor 108 may be configured according to any of the embodiments described herein. The processor 108 also may be configured to perform other functions or additional steps using the output of the system 100 or using images or data from other sources.

The processor 108 may be communicatively coupled to any of the various components or sub-systems of system 100 in any manner known in the art. Moreover, the processor 108 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 108 and other subsystems of the system 100 or systems external to system 100.

Program instructions implementing methods such as those described herein may be transmitted over or stored on carrier medium, such as the electronic data storage unit 109. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 108 (or computer subsystem 102) or, alternatively, multiple processors 108 (or multiple computer subsystems 102). Moreover, different sub-systems of the system 100 may include one or more computing or logic systems. Therefore, the above description should not be interpreted as a limitation on the present disclosure but merely an illustration.

Rooted in neural network technology, deep learning is a probabilistic graph model with many neuron layers, commonly known as a deep architecture. Deep learning technology processes the information such as image, text, voice, and so on in a hierarchical manner. Generally speaking, deep learning (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a deep network, there are many layers between the input and output, allowing the algorithm to use multiple processing layers, composed of multiple linear and non-linear transformations.

Deep learning is part of a broader family of machine learning methods based on learning representations of data. An observation (e.g., a feature to be extracted for reference) can be represented in many ways such as a vector of intensity values per pixel or in a more abstract way like a set of edges, regions of particular shape, etc. Some representations are better than others at simplifying the learning task (e.g., face recognition or facial expression recognition). Deep learning can provide efficient algorithms for unsupervised or semi-supervised feature learning and hierarchical feature extraction.

In an embodiment, the deep learning model is configured as a neural network. In a further embodiment, the deep learning model may be a deep neural network with a set of weights that model the world according to the data that it has been fed to train it. Neural networks can be generally defined as a computational approach based on a relatively large collection of neural units loosely modeling the way a biological brain solves problems with relatively large clusters of biological neurons connected by axons. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Neural networks typically include multiple layers, and the signal path traverses from front to back. The goal of the neural network is to solve problems in the same way that the human brain would, although several neural networks are much more abstract. Modern neural network projects typically work with a few thousand to a few million neural units and millions of connections. The neural network may have any suitable architecture and/or configuration known in the art.

Generative adversarial networks (GANs) provide generative modeling using deep learning methods, such as convolutional neural networks. Generative modeling is an unsupervised learning task in machine learning that involves automatically discovering and learning the regularities or patterns in input data so that the model can be used to generate or output new examples that plausibly could have been determined from the original dataset.

GANs train a generative model by framing the problem as a supervised learning problem with two sub-models. First, there is a generator model that is trained to generate new examples. Second, there is a discriminator model that tries to classify examples as either real (from the domain) or fake (generated). The two models are trained together in a zero-sum game (i.e., adversarial) until the discriminator model is fooled enough that the generator model is generating plausible examples.

A region of the design file that corresponds to the workpiece image can be used in the method. The features of the die may be in both the design file and the workpiece image.

An infrastructure with high performance computing accelerators (e.g., graphics processing unit (GPU)) may be used to train the network with examples of design files, design images, and images of the workpiece.

While the embodiments disclosed herein are disclosed with respect to images formed with an electron beam or an ion beam, optical images also can be used for defect detection and inspection. Thus, the image that is aligned to the synthetic image may be formed using an electron beam, ion beam, beam of light, or other techniques.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
receiving a design image of a semiconductor device structure on part of a surface of a workpiece;
generating a synthetic image of the semiconductor device structure from the design image using a symmetric CycleGAN, wherein the symmetric CycleGAN comprises a neural network architecture configured to learn bidirectional mappings between a design image domain and a workpiece image domain; and
aligning the synthetic image to a workpiece image of the device structure on the workpiece corresponding to the synthetic image thereby generating an aligned image, wherein the aligning is provided by domain translation performed by the symmetric CycleGAN.

2. The method of claim 1, further comprising imaging the device structure on the workpiece corresponding to the synthetic image using an electron beam inspection system thereby generating the workpiece image.

3. The method of claim 1, further comprising performing defect detection using the aligned image.

4. The method of claim 1, wherein the symmetric CycleGAN is configured to achieve symmetry using symmetric kernels in convolutional layers of a neural network of the symmetric CycleGAN.

5. The method of claim 1, further comprising performing a regularization, wherein the regularization includes a dynamic weighting mechanism applied to normalized cross-correlation (NCC) loss, the dynamic weighting mechanism being configured to emphasize regions of low similarity or high uncertainty between fixed and moving images.

6. An inspection system comprising:
a stage configured to hold a workpiece;
an electron beam source configured to direct an electron beam at the workpiece on the stage;
a detector configured to collect secondary electrons and/or back scattered electrons from the workpiece; and
a processor in electronic communication with the detector, wherein the processor is configured to:
receive a design image of a semiconductor device structure on part of a surface of the workpiece;
generate a synthetic image of the semiconductor device structure from the design image using a symmetric CycleGAN, wherein the symmetric CycleGAN comprises a neural network architecture configured to learn bidirectional mappings between a design image domain and a workpiece image domain; and
align the synthetic image to a workpiece image of the device structure on the workpiece corresponding to the synthetic image thereby generating an aligned image, wherein the aligning is provided by domain translation performed by the symmetric CycleGAN.

7. The inspection system of claim 6, wherein the processor is further configured to send instructions to image the device structure on the workpiece corresponding to the synthetic image using the electron beam thereby generating the workpiece image.

8. The inspection system of claim 6, wherein the processor is further configured to perform defect detection using the aligned image.

9. The inspection system of claim 6, wherein the symmetric CycleGAN is configured to achieve symmetry using symmetric kernels in convolutional layers of a neural network of the symmetric CycleGAN.

10. The inspection system of claim 6, f wherein the processor is further configured to perform a regularization, wherein the regularization includes a dynamic weighting mechanism applied to NCC loss, the dynamic weighting mechanism being configured to emphasize regions of low similarity or high uncertainty between fixed and moving images.

11. A non-transitory computer-readable storage medium, comprising one or more programs for executing the following steps on one or more computing devices:
receiving a design image of a semiconductor device structure on part of a surface of a workpiece;
generating a synthetic image of the semiconductor device structure from the design image using a symmetric CycleGAN, wherein the symmetric CycleGAN comprises a neural network architecture configured to learn bidirectional mappings between a design image domain and a workpiece image domain; and
aligning the synthetic image to a workpiece image of the device structure on the workpiece corresponding to the synthetic image thereby generating an aligned image, wherein the aligning is provided by domain translation performed by the symmetric CycleGAN.

12. The non-transitory computer-readable storage medium of claim 11, wherein the steps include sending instructions to image the device structure on the workpiece corresponding to the synthetic image using a scanning electron microscope thereby generating the workpiece image.

13. The non-transitory computer-readable storage medium of claim 11, wherein the steps include performing defect detection using the aligned image.

14. The non-transitory computer-readable storage medium of claim 11, wherein the symmetric CycleGAN is configured to achieve symmetry using symmetric kernels in convolutional layers of a neural network of the symmetric CycleGAN.

15. The non-transitory computer-readable storage medium of claim 11, wherein the steps include performing a regularization, wherein the regularization includes a dynamic weighting mechanism applied to NCC loss, the dynamic weighting mechanism being configured to emphasize regions of low similarity or high uncertainty between fixed and moving images.
